(19) United States
(12) Patent Application Publication
(10) Pub. No.: US 2010/0072879 A1
(43) Pub. Date: Mar. 25, 2010

(54) FIELD EMISSION DEVICE WITH ANODE COATING

(75) Inventors: Adam Fennimore, Wilmington, DE (US); David Herbert Roach, Hockessin, DE (US); Lap-Tak Andrew Cheng, Newark, DE (US)

Correspondence Address: E I DU PONT DE NEMOURS AND COMPANY;LEGAL PATENT RECORDS CENTER, BARLEY MILL PLAZA 25/1122B, 4417 LANCASTER PIKE, WILMINGTON, DE, 19805, US

(73) Assignee: E. I. DU PONT DE NEMOURS AND COMPANY, Wilmington, DE (US)

(21) Appl. No.: 12/525,696

(22) PCT Filed: Feb. 22, 2008
(86) PCT No.: PCT/US08/02343

§ 371 Date: Nov. 4, 2009

Related U.S. Application Data
(60) Provisional application No. 60/903,259, filed on Feb. 24, 2007.

(51) Int. Cl. H01J 1/62; H01J 9/02

(52) U.S. Cl. 313/496; 445/35; 977/939

(57) ABSTRACT

A field emission device in which a protective material is employed in relation to the anode wherein the protective material is selected from one or more members of the group consisting of amorphous carbon, graphite, diamond-like carbon, fullerenes, carbon nanotubes, a (co)polymer and an organic coating compound.

This application claims the benefit of U.S. Provisional Application No. 60/903,259, filed 24 Feb. 2007, which is by this reference incorporated in its entirety as a part hereof for all purposes.

### TECHNICAL FIELD

This invention involves a field emission device in which protective material(s) are provided for use in relation to the anode.

### BACKGROUND

A field emission device may produce visible light for display or lighting applications, or x-rays for analytical instruments. The typical field emission device contains an anode and a cathode, and the cathode typically contains a material with a large electric field enhancement. This material may, for example, be conical or acicular to achieve the needed field enhancement when a voltage is applied to the cathode.

An acicular material that is commonly employed in the cathode of a field emission device is carbon nanotubes (“CNTs”), which may be single wall or multi walled tubes. The CNTs may be incorporated into a thick film paste and deposited on the cathode structure for the purpose of fabricating the field emission device. The field emission device typically operates in a partial vacuum of about 1×10⁻⁶ Torr, which enables electrons liberated by the emitting material to transit from the cathode to the anode.

In this partial vacuum, there may be enough oxygen or water vapor present to degrade the field emission of the electron emitting material. Degradation may result in a lower emission current at a given voltage, or in the need to increase the applied voltage over time to maintain the same emission current. The degradation is thought to result from the presence of ions and radicals that are formed by the electron bombardment of the surface of the anode surface, and from the presence of other free reactive gasses. These ions, radicals and other reactive gasses appear to cause degradation of field emission from the cathode by reacting with the electron emitting material. A similar problem is believed to exist when a metal, such as the so-called “Spindt tip”, is used as an acicular emitting material in the cathode.

Carbon materials and polymers have previously been used for various purposes in the manufacture of a field emission device. For example, U.S. Ser. No. 06/284,539 describes a coating of diamond-like carbon on the anode of a field emission device to aid electron emission due to the asperities in the diamond-like coating. U.S. Ser. No. 06/197,428 describes a carbon-containing black matrix surrounding the phosphor on the anode of a field emission device.

Where polymers have previously been used to construct the anode of a field emission device, they have typically been used in thick film printing of the phosphor layer, in the photoresist for a patterned anode, or for laminating a thin aluminum film on the phosphor. In such cases, however, care is usually taken to remove from the anode all residues of these polymers through firing and cleaning steps prior to sealing of the field emission device.

A need consequently remains for the selection and utilization in a field emission device of protective material(s) that may be used in relation to the anode with the objective of reducing degradation of the cathode.

### SUMMARY

In one embodiment, this invention provides a field emission device that includes an anode that comprises one or more members of the group of protective materials consisting of amorphous carbon, graphite, diamond-like carbon, fullerenes, carbon nanotubes, a (co)polymer and an organic coating compound.

In another embodiment, this invention provides a field emission device including an anode that comprises (a) a layer of phosphor material, and (b) disposed on the phosphor layer a layer prepared from one or more members of the group of protective materials consisting of amorphous carbon, graphite, diamond-like carbon, fullerenes, carbon nanotubes, a (co)polymer and an organic coating compound.

In a further embodiment, this invention provides a field emission device including an anode that comprises layer that is prepared from a mixture of (a) phosphor materials, and (b) one or more members of the group of protective materials consisting of amorphous carbon, graphite, diamond-like carbon, fullerenes, carbon nanotubes, a (co)polymer and an organic coating compound.

In another embodiment, this invention provides a display device that includes a field emission device as described above.

In another embodiment, this invention provides a method of fabricating a field emission device by (a) providing as the anode therein a substrate, and (b) coating on the substrate a layer formed from a mixture of (i) phosphor material, and (ii) one or more members of the group of protective materials consisting of amorphous carbon, graphite, diamond-like carbon, fullerenes, carbon nanotubes, a (co)polymer and an organic coating compound.

In another embodiment, this invention provides a method of fabricating a field emission device by (a) providing as the anode therein a substrate, (b) coating on the substrate a layer formed from phosphor material, and (c) coating on the phosphor layer a layer formed from one or more members of the group of protective materials consisting of amorphous carbon, graphite, diamond-like carbon, fullerenes, carbon nanotubes, a (co)polymer and an organic coating compound.

### BRIEF DESCRIPTION OF THE DRAWINGS

FIG. 1 shows a graph comparing the applied voltage required to maintain a constant emission current for the devices tested in Example 1.

FIG. 2 shows a graph comparing the applied voltage required to maintain a constant emission current for the devices tested in Example 2.

FIG. 3 shows a graph comparing the applied voltage required to maintain a constant emission current for the devices tested in Examples 2 and 3.

FIG. 4 shows a graph comparing the applied voltage required to maintain a constant emission current for the devices tested in Example 4.

### DETAILED DESCRIPTION

The anode of a field emission device contains an electrical conductor to collect emitted electrons with which it is bombarded. If the device is a video display, the anode also comprises a layer of phosphor material that emits light when struck by the emitted electrons. In this invention, the anode of the field emission device is improved by providing as a part of the anode a protective layer prepared from one or more of the protective material(s) disclosed herein, or by admixing with phosphor, and incorporating into the phosphor layer, one or more of the those protective material(s).

Although the invention is not limited to any particular theory of operation, it is believed that the presence of the protective material(s) extends the lifetime of the electron emitting material, and thus ultimately the field emission device itself, by reacting with the free radicals and ions produced at the anode when molecules on the surface thereof are bombarded by electrons. The primary source of these ions and radicals is believed to include surface adsorbed water. After having reacted at the anode or anode surface with the protective material(s), these ions and radicals no longer free to react with the emitting materials on the cathode and cause degradation of their field emission. Local heating of the anode may promote reaction of the protective material(s) with ions and radicals derived from water and oxygen in the device, thus consuming gasses that could react with and degrade electron emitting materials. One preferred embodiment thus involves providing the reactive species with ready access to the protective material(s) for reaction therewith, and this objective may be achieved for example when the outer layer of the anode (i.e., that closest to the cathode) is a layer of protective material(s) (a “protective layer”) that is located directly at the point of electron impact and is maximized in surface area.

In one embodiment of this invention, a protective layer may be formed by coating the surface of the anode with protective material(s). The protective material(s) from which a protective layer may be prepared include one or more members of the group consisting of amorphous carbon, graphite, diamond-like carbon, fullerenes, carbon nanotubes, a (co)polymer and an organic coating compound. Fabrication of a protective layer on an anode may be accomplished by any of a variety of coating techniques. The protective material(s) to be coated may, for example, be suspended in a solvent and then spin cast, sprayed, printed, electrodeposited, or deposited using thin film techniques such as sputter coating, electron beam or thermal evaporation, sublimation, or chemical vapor deposition (CVD). The protective layer as coated does not necessarily need to be homogenous, or to completely encapsulate any layers beneath it, to provide its protective function.

In another embodiment of this invention, where for example the field emission device is a display and the anode thus contains a phosphor layer, protective material(s) as described above may be mixed with the phosphor powders and applied to the anode as a part of the phosphor layer. Alternatively, a phosphor layer may be applied as is conventionally done, and a protective layer may be disposed on the phosphor layer by coating protective material(s) on the phosphor layer.

As stated above, the protective material(s) may include various forms of carbon or carbon-containing materials such as amorphous carbon, graphite, diamond-like carbon, fullerenes or carbon nanotubes. Amorphous carbon is carbon that does not have any crystalline structure, and, although some short-range order can be observed, there is generally no long-range pattern of atomic positions. Amorphous carbon, however, frequently contains crystallites of graphite or diamond with varying amounts of amorphous carbon holding them together, making them technically polycrystalline or nanocrystalline materials. Amorphous carbon as used herein also includes soot and carbon black. Graphite, one of the most common allotropes of carbon, is characterized by hexagonal layers of carbon atoms that typically have adsorbed air and water between the layers. There is loose interlamellar coupling between sheets in the structure due to delocalization of the pi bond electrons above and below the planes of the carbon atoms. In graphite, each carbon atom uses only 3 of its 4 outer energy level electrons in covalently bonding to three other carbon atoms in a plane, and each carbon atom contributes one electron to a delocalised system of electrons that is also a part of the chemical bonding.

Diamond like carbon (“DLC”) is a form of amorphous carbon that displays some of the unique properties of natural diamond. DLC contains significant amounts of sp³ hybridized carbon atoms, and can be found in two crystalline polytypes. The usual one has its carbon atoms arranged in a cubic lattice, while the very rare one (lonsdaleite) has a hexagonal lattice. By mixing these polytypes in various ways at the nanoscale level of structure, DLC coatings can be made that at the same time are amorphous, flexible and yet purely sp³ bonded “diamond”. DLC is typically produced by processes in which high energy precursive carbons (e.g. in plasmas, in sputter deposition and in ion beam deposition) are rapidly cooled or quenched on relatively cold surfaces. In those cases, cubic and hexagonal lattices can be randomly intermixed, layer by atomic layer, because there is no time available for one of the crystalline geometries to grow at the expense of the other before the atoms are “frozen” in place in the material. The sp³ bonds can occur not only with crystals—i.e., in solids with long-range order—but also in amorphous solids where the atoms are in a random arrangement. In this case, there will be bonding only between a few individual atoms and not in a long-range order extending over a large number of atoms. If the sp² type is predominant, the film will be softer, and if the sp³ type is predominant, the film will be harder.

Fullerenes are allotropes of carbon wherein molecules are composed entirely of carbon and take the form of a hollow sphere, ellipsoid or tube. Fullerenes are similar in structure to graphite, which is composed of a sheet of linked hexagonal rings, but they contain pentagonal (or sometimes heptagonal) rings that prevent the sheet from being planar. Carbon nanotubes are cylindrical carbon molecules that may be envisioned as a cylinder formed by rolling up a graphene sheet, and typically have at least one end capped with a hemisphere of a fullerene type structure. The diameter of a nanotube is on the order of a few nanometers while they can be up to several centimeters in length. There are two main types of nanotubes: single-walled nanotubes (SWNTs) and multi-walled nanotubes (MWNTs). Carbon nanotubes may also have fullerene like “buds” covalently attached to the outer sidewalls of the tubes. Fullerenes and carbon nanotubes are also described in U.S. application Ser. No. 11/205,452, which is by this reference incorporated in its entirety as a part hereof for all purposes.

A (co)polymer (i.e. a polymer or a copolymer) that may be used herein as a protective material may include, for example, one or more of polyvinyl alcohol, ethyl cellulose, polyacrylonitrile, polyvinyl chloride, polyvinyl pyrrolidone, polypropylene, polyolefins including polyethylene, polyesters including polyethylene terephthalate, acrylic/acrylate polymers including polymethyl methacrylate, polyamide, polycarbonate, polystyrene, parylene, polysaccharides. Suitable (co)polymers also include other polymers that are solid at room temperature, having predominantly a carbon backbone, and are reactive with the kinds of degradative species found in a field emission device such as those generated from water. When a (co)polymer is applied to an anode as a protective material, it may be applied by spin coating, spray coating, various printing techniques and slot die coating. Various (co)polymers may alternatively be deposited using thin film techniques including sublimation and chemical vapor deposition (CVD).

An organic coating material as used herein as a protective material may include, for example, a material that is solid at room temperature and has a low enough vapor pressure that it will not evaporate completely within the vacuum that exists within a field emission device. A suitable organic coating material may, for example, have a vapor pressure at 25° C. of less than about 10⁻⁶ Torr. Examples of organic coating materials suitable for use herein as a protective material include polycyclic aromatics (e.g. perylene or pyrene), polycyclic heteroaromatics, porphyrins, phthalocyanines and carbohydrates. Materials such as these may be suspended in a solvent and then spin cast or sprayed onto the anode. Some of these materials can alternatively be deposited using thin film techniques including sublimation and chemical vapor deposition (CVD).

Protective materials and phosphor powders suitable for use in this invention may be made by processes known in the art, or are available commercially from suppliers such as Alfa Aesar (Ward Hill, Mass.), City Chemical (West Haven, Conn.), Fisher Scientific (Fairlawn, N.J.), Sigma-Aldrich (St. Louis, Mo.) or Stanford Materials (Aliso Viejo, Calif.).

In this invention, protective material(s) may be utilized either by forming therefrom a protective layer that is disposed on the surface of the anode, including on top of any other layers that have previously been applied to the anode, or by admixing protective material(s) with phosphor powders to prepare a coating formulation that is applied as a mixture of such components as the surface of the anode. Coating mixtures may also be formed from protective material(s) and materials to be applied to the anode in addition to or other than phosphor powders. When protective material(s) are prepared in admixture with phosphor and/or another component and the mixture is then applied as a coating formulation to the surface of the anode, the protective material(s) may constitute about 5 to about 50 wt %, or about 10 to about 40 wt %, or about 15 to about 20 wt % of the mixture in relation to the weight of the total mixture.

A protective layer, or a layer in which protective material(s) are admixed as a component, will preferably be located on the surface of the anode and directly in the path of the electrons emitted from the cathode, and the surface of such a layer will preferably be smooth and without roughness or asperities. The protective material(s) are believed to prolong the lifetime of the cathode and thus the device by preferentially reacting with degradative species and thus inhibiting degradation of the electron emitting material.

In general, the effect of the protective materials to reduce the rate of degradation of the emitter in a field emission device will be enhanced, for example, by providing a greater amount of protective material in admixture with phosphor powder to form a mixed phosphor layer, operating the device at a lower level of vacuum, operating the device to produce a lower level of emission, and using a larger spacing between cathode and anode in the construction of the vacuum chamber of the device.

In a field emission device, an electron emitting material is disposed on a cathode and, when energized, bombards an anode with electron. The electron emitting material may be an acicular substance such as carbon, a semiconductor, a metal or mixtures thereof. As used herein, “acicular” means particles with aspect ratios of 10 or more. Typically, glass frit, metallic powder or metallic paint or a mixture thereof is used to attach the electron emitting material to a substrate in the cathode assembly.

Acicular carbon as used as the electron emitting material may be of various types, but carbon nanotubes are the preferred acicular carbon and single wall carbon nanotubes are especially preferred. Carbon fibers grown from the catalytic decomposition of carbon-containing gases over small metal particles are also useful as acicular carbon, and other examples of acicular carbon are polyacrylonitrile-based (PAN-based) carbon fibers and pitch-based carbon fibers.

Various processes can be used to attach an electron emitting material to a substrate. The means of attachment must withstand and maintain its integrity under the conditions of manufacturing the apparatus into which the field emitting cathode is placed and under the conditions surrounding its use, e.g. typically vacuum conditions and temperatures up to about 450° C. A preferred method is to screen print a paste comprised of the electron emitting material and glass frit, metallic powder or metallic paint or a mixture thereof onto a substrate in the desired pattern and to then fire the dried patterned paste. For a wider variety of applications, e.g. those requiring finer resolution, the preferred process comprises screen printing a paste which further comprises a photoinitiator and a photohardenable monomer, photopatterning the dried paste and firing the patterned paste.

The substrate can be any material to which the paste composition will adhere. If the paste is non-conducting and a non-conducting substrate is used, a film of an electrical conductor to serve as the cathode electrode and provide means to apply a voltage to the electron emitting material will be needed. Silicon, a glass, a metal or a refractory material such as alumina can serve as the substrate. For display applications, the preferable substrate is glass and soda lime glass is especially preferred. For optimum conductivity on glass, silver paste can be pre-fired onto the glass at 500-550° C. in air or nitrogen, but preferably in air. The conducting layer so-formed can then be over-printed with the emitter paste.

The paste used for screen printing typically contains the electron emitting material, an organic medium, solvent, surfactant and either low softening point glass frit, metallic powder or metallic paint or a mixture thereof. The role of the medium and solvent is to suspend and disperse the particulate constituents, i.e. the solids, in the paste with a proper rheology for typical patterning processes such as screen printing. There are many organic media known for use for such purpose including cellulosic resins such as ethyl cellulose and alkyd resins of various molecular weights. Butyl carbitol, butyl carbitol acetate, dibutyl carbitol, dibutyl phthalate and terpineol are examples of useful solvents. These and other solvents are formulated to obtain the desired viscosity and volatility requirements.

A glass frit that softens sufficiently at the firing temperature to adhere to the substrate and to the electron emitting material is also used. A lead or bismuth glass frit can be used as well as other glasses with low softening points such as calcium or zinc borosilicates. If a screen printable composition with higher electrical conductivity is desired, the paste may also contain a metal, for example, silver or gold. The paste typically contains about 40 wt % to about 80 wt % solids based on the total weight of the paste. These solids include the electron emitting material and glass frit and/or metallic components. Variations in the composition can be used to adjust the viscosity and the final thickness of the printed material.

The emitter paste is typically prepared by three-roll milling a mixture of the electron emitting material, organic medium, surfactant, solvent and either low softening point glass frit, metallic powder or metallic paint or a mixture thereof. The paste mixture can be screen printed using, for example, a 165-400-mesh stainless steel screen. The paste can be deposited as a continuous film or in the form of a desired pattern. When the substrate is glass, the paste is then fired at a temperature of about 350° C. to about 550° C., preferably at about 450° C. to about 525° C., for about 10 minutes in nitrogen. Higher firing temperatures can be used with substrates which can endure them provided the atmosphere is free of oxygen. However, the organic constituents in the paste are effectively volatilized at 350-450° C., leaving a layer of the composite of the electron emitting material and glass and/or metallic conductor. The electron emitting material appears to undergo no appreciable oxidation or other chemical or physical change during the firing in nitrogen.

If the screen-printed paste is to be photopatterned, the paste may also contain a photoinitiator, a developable binder and a photohardenable monomer comprised, for example, of at least one addition polymerizable ethylenically unsaturated compound having at least one polymerizable ethylenic group. Typically, a paste prepared from an electron emitting material such as carbon nanotubes, silver and glass frit will contain about 0.01-6.0 wt % nanotubes, about 40-75 wt % silver in the form of fine silver particles and about 3-15 wt % glass frit based on the total weight of the paste.

The anode of the device is an electrode coated with an electrically conductive layer. When the field emission device is used in a display device where the cathode contains an array of pixels of the thick film paste deposits described above, the anode in the display device may comprise phosphors to convert incident electrons into light. The substrate of the anode would also be selected to be transparent so that the resulting light could be transmitted. From the cathode assembly and anode, a sealed unit is constructed in which the cathode assembly and anode are separated by spacers, and there is an evacuated space between the anode and the cathode. This evacuated space needs to be under partial vacuum so that the electrons emitted from the cathode may transit to the anode with only a small number of collisions with gas molecules. Frequently the evacuated space is evacuated to a pressure of less than 10⁻⁵ Torr.

Such a field emission device is useful in a variety of electronic applications, e.g. vacuum electronic devices, flat panel computer and television displays, back-light source for LCD displays, emission gate amplifiers, and klystrons and in lighting devices. For example, flat panel displays having a cathode using a field emission electron source, i.e. a field emission material or field emitter, and a phosphor capable of emitting light upon bombardment by electrons emitted by the field emitter have been proposed. Such displays have the potential for providing the visual display advantages of the conventional cathode ray tube and the depth, weight and power consumption advantages of the other flat panel displays. The flat panel displays can be planar or curved. U.S. Pat. Nos. 4,857,799 and 5,015,912 disclose matrix-addressed flat panel displays using micro-tip cathodes constructed of tungsten, molybdenum or silicon. WO 94-15352, WO 94-15350 and WO 94-28571 disclose flat panel displays wherein the cathodes have relatively flat emission surfaces. These devices are also described in US 2002/0074932, which is by this reference incorporated in its entirety as a part hereof for all purposes.

The advantageous attributes and effects of this invention may be seen in a series of examples (Examples 1˜4), as described below. The embodiments on which the examples are based are representative only, and the selection of those embodiments to illustrate the invention does not indicate that materials, arrangements, components, ingredients or configurations, not described in these examples are not suitable for practicing this invention, or that subject matter not described in these examples is excluded from the scope of the appended claims and equivalents thereof.

### EXAMPLES

Samples of field emitters were tested in a vacuum chamber where the pressure ranged from about 1×10⁻⁶ to about 1×10⁻⁸ Torr. The cathodes therein were made using a thick film paste containing carbon nanotubes. The thick film paste was patterned on the cathode with a typical pattern of interest. The patterned cathode was then fired at about 420° C. for about 30 minutes in a nitrogen atmosphere. Once fired, the patterned electron emitting film was fractured to expose electron emitting material by laminating the panel with an adhesive tape and removing the tape. Spacers of thickness d=640 μm were then placed on the cathode surface, and an anode of interest is placed on top of the spacers to create a diode field emission device.

Each sample field emitting device was then placed within a vacuum system where electrical contact is made to the anode and cathode of each device. A high voltage pulsed square wave (V_{C}) was applied to the cathode of the sample to establish an emission current. To maintain a fixed current a DC bias is applied to the anode (V_{A}). Degradation of emission current directly corresponds to the rate at which the total applied field [(V_{A}−V_{C})/d] increases. As the emitters degrade, a larger electric field is needed to compensate for their degradation, thus the rate of increase of total applied field directly corresponds to the degradation rate. Lower rates of increase in applied field indicate a lower degradation rate and thus an advantage in the lifespan or lifetime of the field emission device.

### Example 1

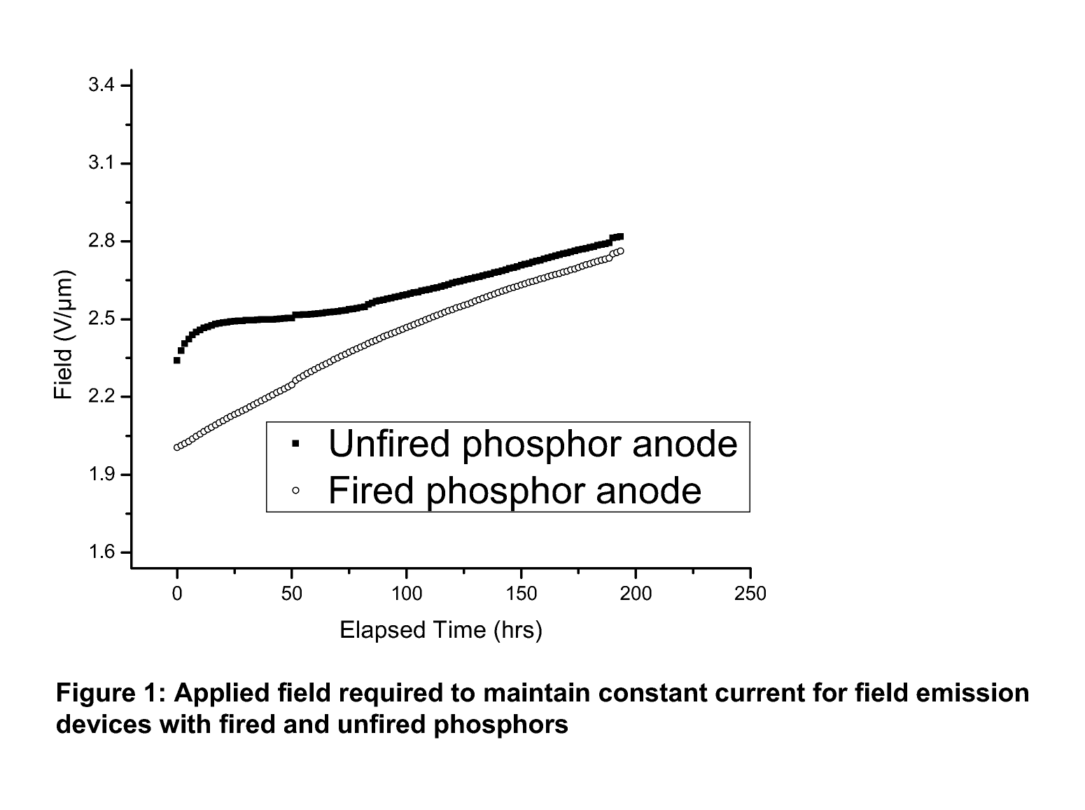

FIG. 1 shows the applied electric field required to maintain a constant emission current from two different samples of a field emission device run simultaneously in the same vacuum chamber. The curve of solid black squares corresponds to a sample with a phosphor layer that is unfired, while the curve of hollow circles corresponds to a sample with a phosphor layer that has been fired. The primary difference between a fired and unfired phosphor layer is that the unfired phosphor layer contains phosphor powder that remains admixed with a binder material (typically a polymer, in this case ethyl cellulose) because the device has not been subjected to the typical firing, during which the binder is volatilized. In the sample with a fired phosphor layer, the phosphor layer contains no residual binder because of the effect of volatilization as described above.

Initially the rate of degradation (i.e. the rate at which it is necessary to increase the applied voltage to maintain a current emission current) of the sample with an unfired phosphor layer is lower than that of the sample with a fired phosphor layer. This difference in rate of degradation is due to the presence of the residual binder as contained in the unfired phosphor layer. During use, however, the binder is volatilized, and the rate of degradation then begins to increase to match that of the device in which the fired phosphor layer was devoid of binder from the beginning of service. In this example, the addition of a protective material for admixture with phosphor powder in a phosphor layer was provided by the technique of leaving residual binder material in the phosphor layer by omitting a step of firing the phosphor layer.

### Example 2

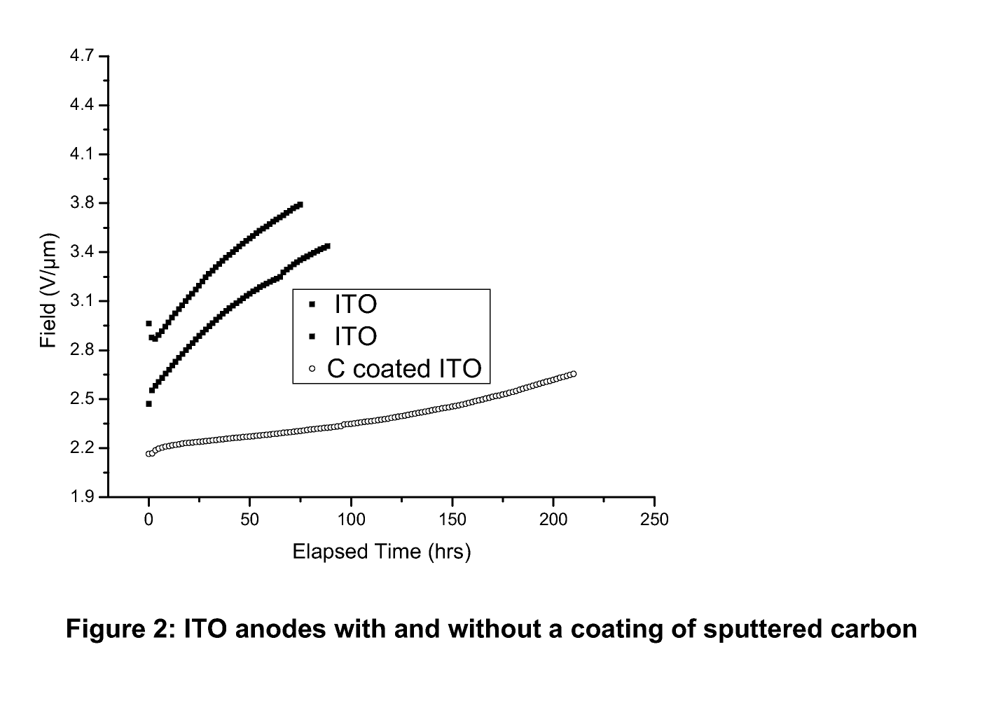

Carbon as a protective material was sputter deposited onto an anode fabricated from ITO (indium tin oxide, a transparent conductive material). The carbon coating was 22 nm thick and amorphous in character. This carbon coated anode was installed in a field emission device, and the rate of degradation of the emitter in that device was compared to a device in which the anode was fabricated from ITO without any coating. In the device with the coated anode, the rate of degradation was markedly lower than that for the device with an uncoated anode, as shown in FIG. 2. However, after about 75 hours, the rate of degradation began to increase, and this increase was due to the consumption of the carbon layer, which could be observed physically when the anode was examined under an optical microscope. The slight decrease in the lower curve of an ITO only anode at 50-70 hours was due to voltage limiting of the DC bias placed on the anode.

### Example 3

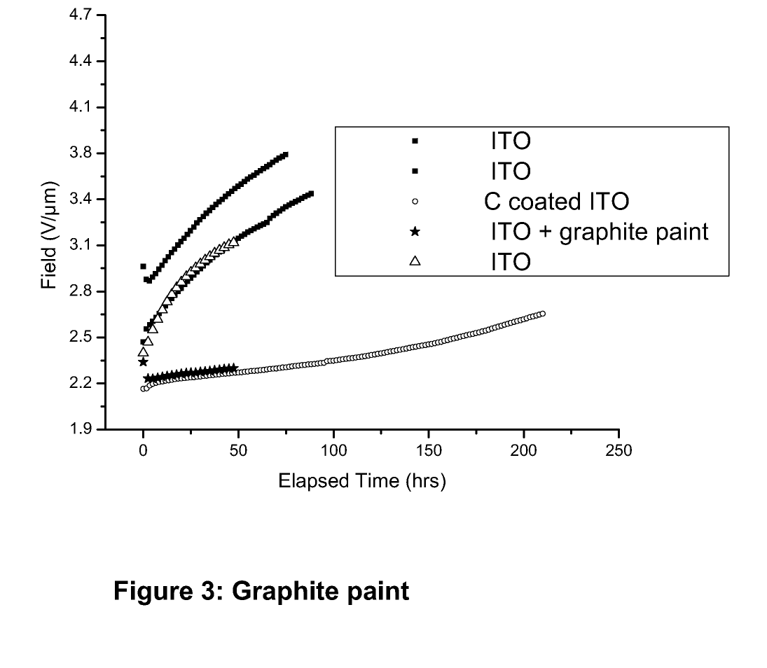

Protective carbon on the anode need not be amorphous or sputter deposited. In this example, an ITO anode was coated by spin coating using a commercially available graphite paint (Neolube No. 2, Huron Industries Inc., Port Huron, Mich. 48061), which contains a mixture of graphitic and amorphous carbon in isopropyl alcohol. FIG. 3 shows that the rate of emitter degradation in a field emission device in which such an anode was installed was similar to that for the device with the carbon coated anode in the Example 2. A device with an uncoated ITO anode run simultaneously exhibited a much larger rate of degradation that was comparable to the performance of the device with the uncoated anode in Example 2.

### Example 4

In a field emission display device, the anode is often an ITO glass substrate coated with phosphor and then an aluminum layer. The aluminum layer acts to maximize the amount of light projected out of the front of the anode and to increase the conductivity of the anode. Conventional devices with this architecture were found to exhibit some of the worst degradation rates.

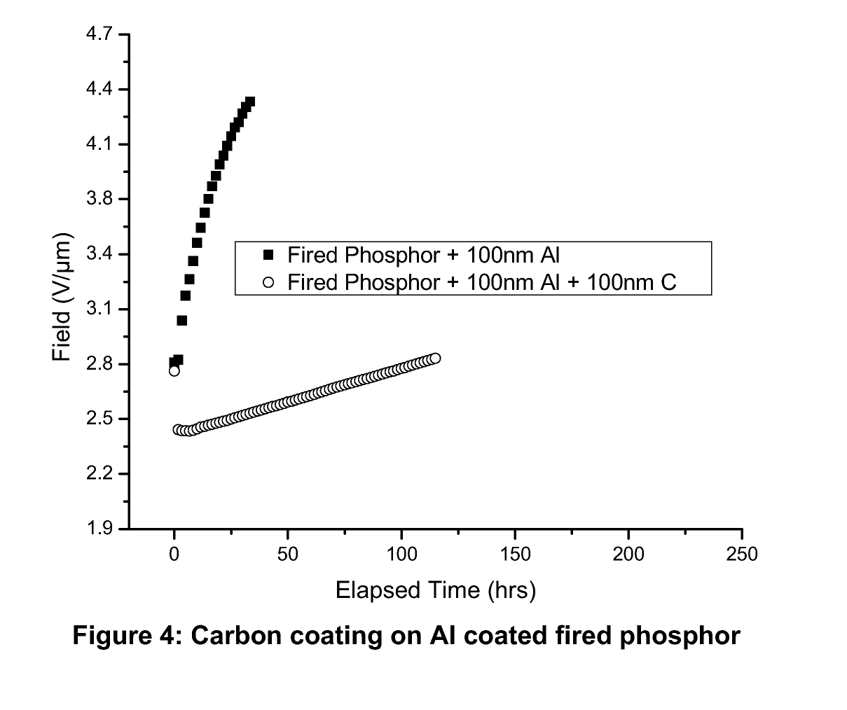

FIG. 4 shows the results for samples of two devices that were run simultaneously, the curve with solid squares corresponding to a sample with an ITO anode coated with phosphor that was then fired and had 100 nm of aluminum deposited via electron beam deposition. The anode in the device represented by the curve with hollow circles was identical except that a layer of 100 nm of carbon was sputter coated on top of the aluminum layer. It may be seen that this final carbon layer drastically reduces the rate of degradation of the emitter in the device with the carbon coated anode. Where the device without the carbon coated anode rapidly degraded until a voltage limit was reached, the device with the carbon coated anode degraded at a much lower rate.

Features of certain of the devices of this invention are described herein in the context of one or more specific embodiments that combine various such features together. The scope of the invention is not, however, limited by the description of only certain features within any specific embodiment, and the invention also includes (1) a subcombination of fewer than all of the features of any described embodiment, which subcombination may be characterized by the absence of the features omitted to form the subcombination; (2) each of the features, individually, included within the combination of any described embodiment; and (3) other combinations of features formed by grouping only selected features of two or more described embodiments, optionally together with other features as disclosed elsewhere herein.

In this specification, unless explicitly stated otherwise or indicated to the contrary by the context of usage, where an embodiment of the subject matter hereof is stated or described as comprising, including, containing, having, being composed of or being constituted by or of certain features or elements, one or more features or elements in addition to those explicitly stated or described may be present in the embodiment. An alternative embodiment of the subject matter hereof, however, may be stated or described as consisting essentially of certain features or elements, in which embodiment features or elements that would materially alter the principle of operation or the distinguishing characteristics of the embodiment are not present therein. A further alternative embodiment of the subject matter hereof may be stated or described as consisting of certain features or elements, in which embodiment, or in insubstantial variations thereof, only the features or elements specifically stated or described are present.

What is claimed is:

1. A field emission device comprising an anode that comprises (a) a layer of phosphor material, and (b) disposed on the phosphor layer a layer prepared from one or more members of the group of protective materials consisting of amorphous carbon, graphite, diamond-like carbon, fullerenes, carbon nanotubes, a (co)polymer and an organic coating compound.

2. A device according to claim 1 wherein the layer formed from protective material(s) forms the surface of the anode.

3. A device according to claim 1 which comprises a cathode comprising carbon nanotubes.

4. A device according to claim 1 wherein the protective material comprises carbon.

5. A device according to claim 1 wherein the protective material comprises a (co)polymer.

6. A display device comprising a field emission device according to claim 1.

7. A field emission device comprising an anode that comprises layer that is prepared from a mixture of (a) phosphor materials, and (b) one or more members of the group of protective materials consisting of amorphous carbon, graphite, diamond-like carbon, fullerenes, carbon nanotubes, a (co)polymer and an organic coating compound.

8. A device according to claim 7 wherein the layer formed from the mixture forms the surface of the anode.

9. A device according to claim 7 which comprises a cathode comprising carbon nanotubes.

10. A device according to claim 7 wherein the protective material comprises carbon.

11. A device according to claim 7 wherein the protective material comprises a (co)polymer.

12. A display device comprising a field emission device according to claim 7.

13. A method of fabricating a field emission device comprising (a) providing as the anode therein a substrate, and (b) coating on the substrate a layer formed from a mixture of (i) phosphor material, and (ii) one or more members of the group of protective materials consisting of amorphous carbon, graphite, diamond-like carbon, fullerenes, carbon nanotubes, a (co)polymer and an organic coating compound.

14. A method according to claim 13 wherein the protective material comprises carbon.

15. A method according to claim 13 wherein the protective material comprises a (co)polymer.

16. A method of fabricating a field emission device comprising (a) providing as the anode therein a substrate, (b) coating on the substrate a layer formed from phosphor material, and (c) coating on the phosphor layer a layer formed from one or more members of the group of protective materials consisting of amorphous carbon, graphite, diamond-like carbon, fullerenes, carbon nanotubes, a (co)polymer and an organic coating compound.

17. A method according to claim 16 wherein the protective material comprises carbon.

18. A method according to claim 16 wherein the protective material comprises a (co)polymer.
